(19) United States
(12) Patent Application Publication
(10) Pub. No.: US 2006/0143244 A1
(43) Pub. Date: Jun. 29, 2006

(54) Semiconductor data archiving management systems and methods

(75) Inventor: Tong-Lung Chia, Chubei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Taiwan Semiconductor Manufacturing Co., Ltd.

(21) Appl. No.: 11/023,900

(22) Filed: Dec. 28, 2004

(51) Int. Cl. G06F 17/30

(52) U.S. Cl. 707/204

(57) ABSTRACT

Systems and methods for data archiving management. A storage device stores archive data and at least one data introduction. The archive data comprising at least one data item corresponding to a data introduction is generated after completing a corresponding semiconductor product, wafer or wafer lot. A processing unit transmits a first Web page comprising the data introduction to a client computer, acquires the data item from the archive data in response to a data preview request, transmits a second Web page comprising the data item to the client computer, and transmits the data item to the client computer in response to a data download request.

### BACKGROUND

The invention relates to semiconductor data management technology, and more particularly, to semiconductor data archiving management methods and systems.

During semiconductor manufacturing, the number of files and records in a database grow over time. In order to maintain reasonable database or file size, files and records are archived. Archive data, however, cannot be directly accessed by customers. A customer typically asks for particular archive data by telephone or e-mail. The operator informs a data administrator to acquire asked archive data by an e-mail, telephone or request application after verifying customer access permissions. Alternatively, the operator responds to the customer that the archive data cannot be provided while the customer has insufficient permissions. The requested archive data is acquired from the archiving system by a data administrator, and subsequently transmitted to an operator. Finally, the operator transmits the requested archive data to the customer. The labor-intensive nature of archive data acquisition using conventional means severely hinders efficiency. Thus, a need exists for systems and methods of semiconductor data archiving management.

### SUMMARY

Systems for data archiving management are provided. An exemplary embodiment comprises a storage device storing archive data and at least one data introduction. Archive data comprising at least one data item is generated after completing a corresponding semiconductor product, wafer or wafer lot. The data introduction corresponds to the data item. A processing unit transmits a first Web page comprising the data introduction including a data identity to a client computer. The data identity corresponds to the data item. The processing unit acquires the data item from the archive data in response to a data preview request with the data identity, transmits a second Web page comprising the data item to the client computer, and transmits the data item to the client computer in response to a data download request with the data identity.

The processing unit may further generate a new log indicating that the data item has been previewed or downloaded by a user account, and store the new log to the storage device. The processing unit may further transmit a notice indicating that the data item has been previewed or downloaded by a user account to an operator. The notice may be transmitted to the operator via e-mail or short message. The processing unit may further determine whether a user account has permission to access the data item, and transmit the corresponding data introduction accordingly. The processing unit may further receive the data item from a fabrication tool, a manufacturing execution system (MES), a management information system (MIS) or a testing equipment, and compress or pack the data item to archive data.

Data archiving management methods are provided. An exemplary method transmits a first Web page comprising a data introduction to a client computer. The data introduction comprises a data identity for a data item, and the data introduction corresponds to the data item. The method acquires the data item from the archive data in response to a data preview request with the data identity. The archive data comprising at least the data item is generated after completion of a corresponding semiconductor product, wafer or wafer lot. The method transmits a second Web page comprising the data item to the client computer, and transmitting the data item to the client computer in response to a data download request with the data identity.

Some embodiments of a method for data archiving management may further generate a new log indicating that the data item has been previewed or downloaded by a user account, and store the new log to a storage device. The method may further transmit a notice indicating that the data item has been previewed or downloaded by a user account to an operator, and the notice is transmitted to the operator via e-mail or short message. The method may further determine whether a user account has permission to access the data item, and transmits the data introduction corresponding to the data item when the user account has permission to access the data item. The data item may further be received from a fabrication tool, a manufacturing execution system (MES), a management information system (MIS) or a testing equipment, and compressed or packed to the archive data.

A machine-readable storage medium storing a computer program which, when executed, performs the method of data archiving management is also disclosed.

The data item may be generated during semiconductor manufacturing. The data item may be a configuration file for a semiconductor fabrication tool, quotation, order, shipment, wafer acceptance test (WAT) data report or circuit probing (CP) test report. The archive data may be uncompressed or unpacked for data item acquisition. The data preview request and the data download request may be compatible with hypertext transfer protocol (HTTP). The first Web page and the second Web page may be compatible with hypertext markup language (HTML).

### DESCRIPTION OF THE DRAWINGS

Semiconductor data archiving management systems and methods will become apparent by referring to the following detailed description of embodiments with reference to the accompanying drawings, wherein:

FIG. 1 is a diagram of an embodiment of a semiconductor data archiving management system;

FIG. 2 is a diagram of a hardware environment applicable to computers in an embodiment of a data archiving management system;

FIG. 3 is a flowchart showing an embodiment of a method for data archiving management;

FIG. 4 is a screen diagram depicts an exemplary Web page comprising a data introduction;

FIG. 5 is a diagram of a storage medium for storing a computer program providing an embodiment of a method of data archiving management.

### DESCRIPTION

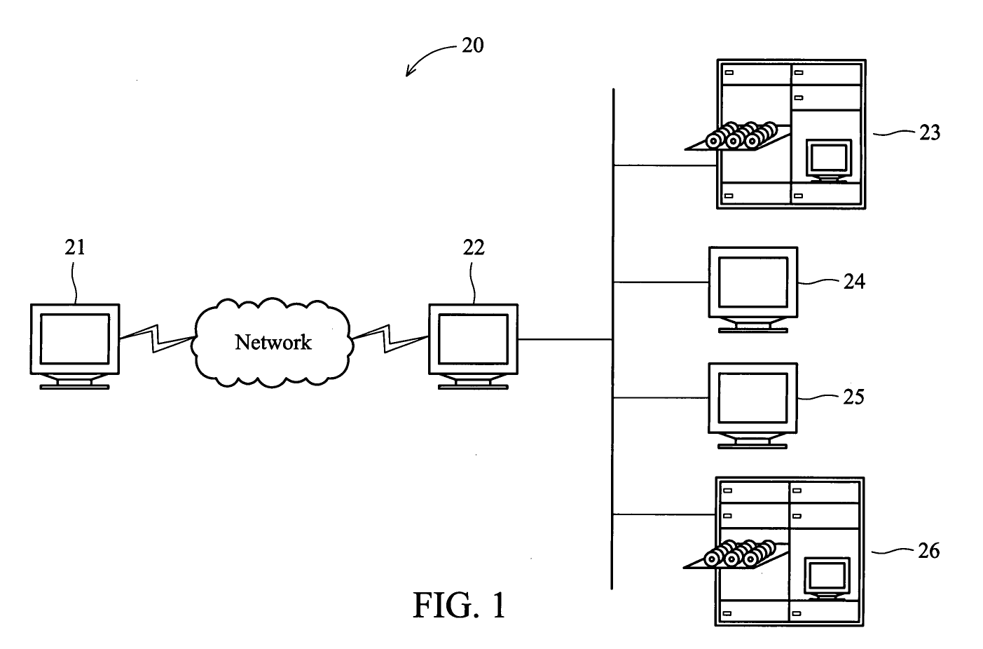

FIG. 1 is a diagram of an embodiment of a semiconductor data archiving management system. The semiconductor data archiving management system 20 comprises a client computer 21, an archiving system 22, a fabrication tool 23, a manufacturing execution system (MES) 24, a management information system (MIS) 25 and a testing tool 26. The client computer 21 operates in a networked environment (preferably an Internet or an Extranet) using logical connections to the archiving system 22. The archiving system 22, fabrication tool 23, MES 24, MIS 25 and testing tool 26 operate in a networked environment (preferably an Internet or an Intranet) using logical connections therebetween. Those skilled in the art will recognize that the client computer 21, archiving system 22, fabrication tool 23, MES 24, MIS 25 and testing tool 26 may be connected in different types of networking environments, and may communicate between different types of networking environments through various types of transmission devices such as routers, gateways, access points, base station systems or others.

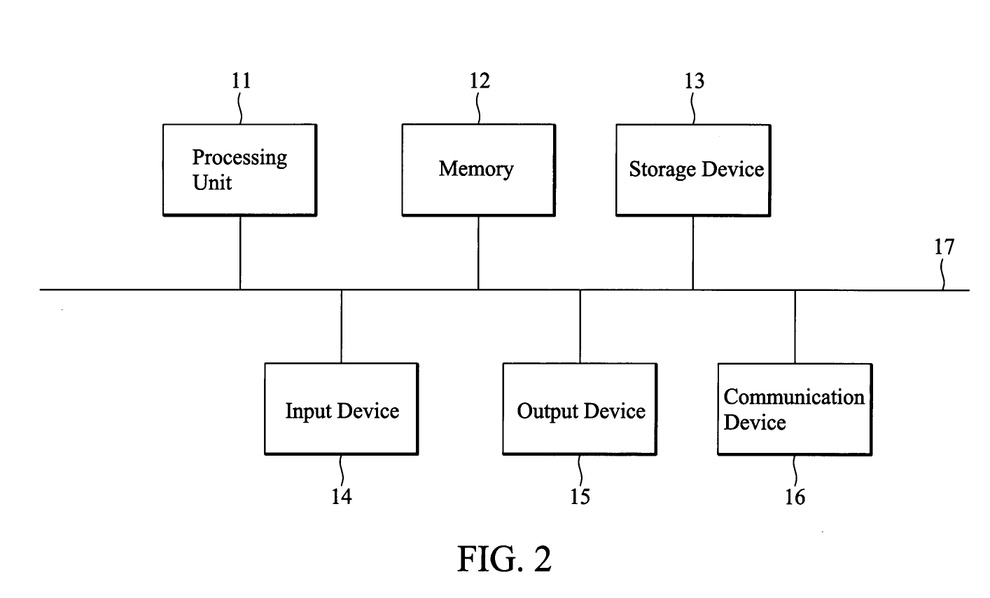

FIG. 2 is a diagram of a hardware environment applicable to computers in an embodiment of a data archiving management system. The description of FIG. 2 provides a brief, general description of suitable computer hardware and a suitable computing environment for computers 21, 22, 24 and 25 in conjunction with which an embodiment of data archiving management systems and methods may be implemented. The hardware environment of FIG. 2 comprises a processing unit 11, a memory 12, a storage device 13, an input device 14, an output device 15 and a communication device 16. The processing unit 11 is connected by buses 17 to the memory 12, storage device 13, input device 14, output device 15 and communication device 16 based on Von Neumann architecture. There may be one or more processing units 21, such that the processor of the computer comprises a single central processing unit (CPU), a microprocessing unit (MPU) or multiple processing units, commonly referred to as a parallel processing environment. The memory 12 is preferably a random access memory (RAM), but may also include read-only memory (ROM) or flash ROM. The memory 12 preferably stores program modules executed by the processing unit 11 to perform data archiving management functions. Generally, program modules include routines, programs, objects, components, or others, that perform particular tasks or implement particular abstract data types. Moreover, those skilled in the art will understand that at least some embodiments may be practiced with other computer system configurations, including hand-held devices, multiprocessor-based, microprocessor-based or programmable consumer electronics, network PCs, minicomputers, mainframe computers, and the like. Some embodiments may also be practiced in distributed computing environments where tasks are performed by remote processing devices linked through a communication network. In a distributed computing environment, program modules may be located in both local and remote memory storage devices based on various remote access architecture such as DCOM, CORBA, Web objects, Web Services or other similar architectures. The storage device 13 may be a hard drive, magnetic drive, optical drive, a portable drive, or nonvolatile memory drive. The drives and associated computer-readable media thereof (if required) provide nonvolatile storage of computer-readable instructions, data structures, program modules, gating rules and gating rule versions (if required). The processing unit 11, controlled by program modules received from the memory 12 and from an operator through the input device 12, directs data archiving management functions. The storage device 13 may comprise a database management system, an object base management system, a file management system, or others, for storing various data.

The client computer 21 can be equipped with a browser to gain access to the archiving system 22. The web browser is a client application or, preferably, an integrated operating system utility that communicates with the archiving system 22. The web browser receives data from the archiving system 22 sent over the Internet that is typically encoded in Hyper Text Markup Language (HTML), Extensible Markup Language (XML) or the like. The web browser typically supports additional components such as Java Applets, ActiveX Controls and Plug-Ins that provide extra functionality.

Integrated circuits are typically fabricated by processing one or more wafers as a “lot” with a series of wafer fabrication tools (i.e., “processing tools”). The fabrication tool 23 typically performs a single wafer fabrication operation upon the wafers in a given lot. For example, a particular fabrication tool may perform a layering operation, a patterning operation, a doping operation or a heat treatment upon the wafers. The wafer fabrication operation is performed according to a predefined procedure (i.e., a predetermined set of steps or “recipe”). The fabrication tool 23 typically stores a configuration file containing numerous recipes for different lots. Such configuration files may be transmitted to the archiving system 22 for archiving.

The MES 24 may be an integrated computer system representing the methods and tools used to accomplish production. For example, the primary functions of the MES 24 include collecting manufacturing data in real time, organizing and storing the manufacturing data in a centralized database, work order management, fabrication tool management and process management. The Grid Description Section (GDS) files provided by customers may also be stored in the centralized database. Examples of the MES (not shown) include Promis (Brooks Automation Inc. of Massachusetts), Workstream (Applied Materials, Inc. of California), Poseidon (IBM Corporation of New York), and Mirl-MES (Mechanical Industry Research Laboratories of Taiwan). Each MES may have a different application area. For example, Mirl-MES may be used in applications involving packaging, liquid crystal displays (LCDs), and printed circuit boards (PCBs), while Promis, Workstream, and Poseidon may be used for IC fabrication and thin film transistor LCD (TFT-LCD) applications. Such manufacturing data may be transmitted to the archiving system 22 for archiving.

The MIS 25 provides various logistic functions, such as order management, quotation management, product data management, production planning, scheduling and the like for semiconductor manufacturing. The MIS 25 organizes and stores the logistic data, such as orders, quotations, semiconductor product specifications and the like, in a centralized database. The product data could include product categories (e.g., par, part numbers, and associated information), as well as a set of process stages that are associated with each category of products. Such logistic data may be transmitted to the archiving system 22 for archiving.

The testing tool 26 may be a Wafer acceptance test (WAT) testing equipment or a circuit probing (CP) testing equipment for performing various testing operation. During integrated circuit fabrication, various test structures are fabricated on a wafer to extract information on the process and device performance for fault analysis. WAT data is generated by electrical measurements of these test structures after completing the entire fabrication process. Several sites located on the fixed locations on each wafer are selected, from which over 100 WAT parameters are measured by the testing tool 26. Statistical analysis and process diagnosis based on end-of-line WAT data provide an assessment of overall process performance and its impact on product yield. Such WAT data and statistical analysis data may be transmitted to the archiving system 22 for archiving. CP testing methods is used in a variety of semiconductor fabrication processes for yield data acquisition. A test program is provided by a user or an operator to perform CP tests for a particular semiconductor product. The test program describes a test flow including multiple test items, and the test items are typically optimally arranged to reduce CP test time. The testing equipment 26 then follows the predefined test flow to sequentially probe all dies on a wafer to determine whether a die is good or bad. After completing the entire CP test, CP test result such as yield values for wafers, wafer lots or semiconductor devices, are acquired. The CP test results may carry into multiple gating rules to generate advisory reports. Each gating rule determines a final advisory such as acceptance, scrap, hold for analysis and the like, for semiconductor devices, dies, wafers, wafer lots or semiconductor products when a CP test attribute such as yield value, quantities of good dies, repairable dies, and the like, or a mathematical operation of CP test attributes satisfying a particular condition. Such WAT data, CP test result or advisory reports may be transmitted to the archiving system 22 for archiving.

An embodiment of an archiving system 22 receives data items, such as GDS files, configuration files, manufacturing data, logistic data, WAT data, CP test result or others, from the fabrication tool 23, MES 24, MIS 25 or testing tool 26. In some embodiments, the received data items may further be compressed by various compression algorithms to reduce data size, and then the compressed data items are stored as archive data in the storage device 13. In some embodiments, the received data items may be packed into a package by packing applications, and then the package is stored as archive data in the storage device 13. In some embodiments, archiving system 22 may generate summary reports, such as weekly report, monthly report, product yield summary, from received data items, and then the summary reports are stored as archive data in the storage device 13. A data introduction comprising archiving date, product finish date, data type, brief description, file size or others, for each data item is generated and stored in the storage device 13. These data introductions may be stored in one or more related tables in a database management system (DBMS), stored in one or more data objects compliant with Unified Modeling Language (UML) in a data object base management system, or stored in one or more text files. The archiving system 22 may provide a graphical user interface (GUI) to facilitate interaction with the generation of the data introductions, such as inserting a new brief introduction, deleting a brief introduction, modifying content of a brief introduction.

An embodiment of an archiving system preferably comprises a Web server executed by the processing unit 11 therein. The Web server comprises several Web pages in response to archive data acquisition requests from the client computer 21. Generally, information provided by the web server is in the form of Web pages, generally in HTML (HyperText mark-up language) format, which is a text-based format that describes how the respective Web page is to be displayed by a computer, and provides textual information, typically in ASCII form, and graphical information generally in a compressed format such as “GIF” or “JPEG.” Such HTML documents may include scripts (e.g., JavaScript, Visual Basic Scripts, Active Server Page Scripts and the like) that provides for some data archiving management functionality.

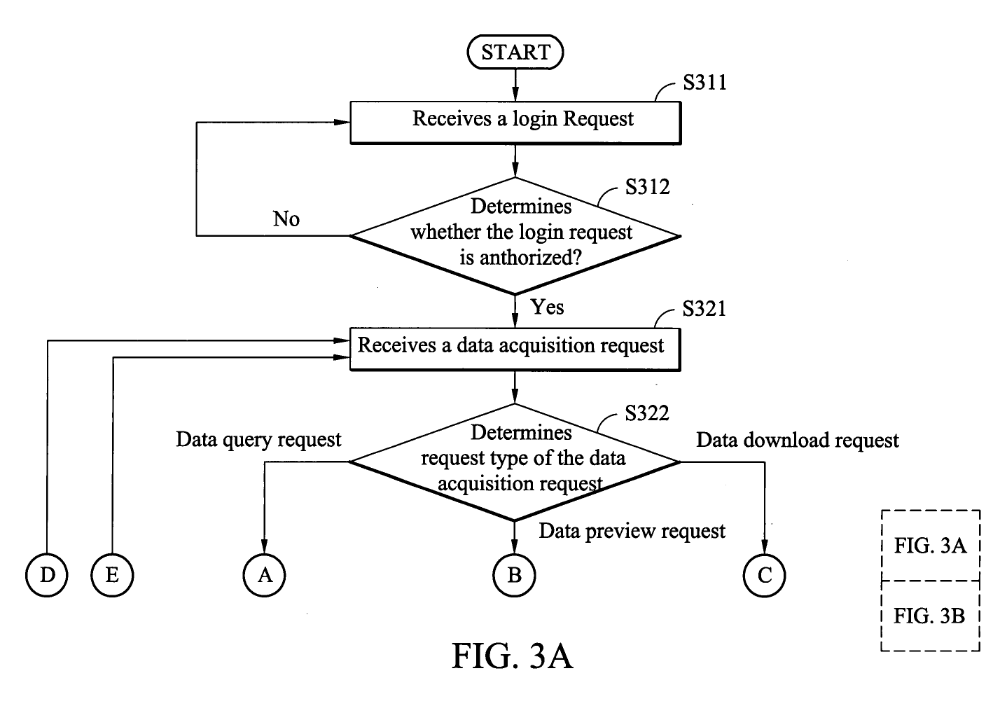

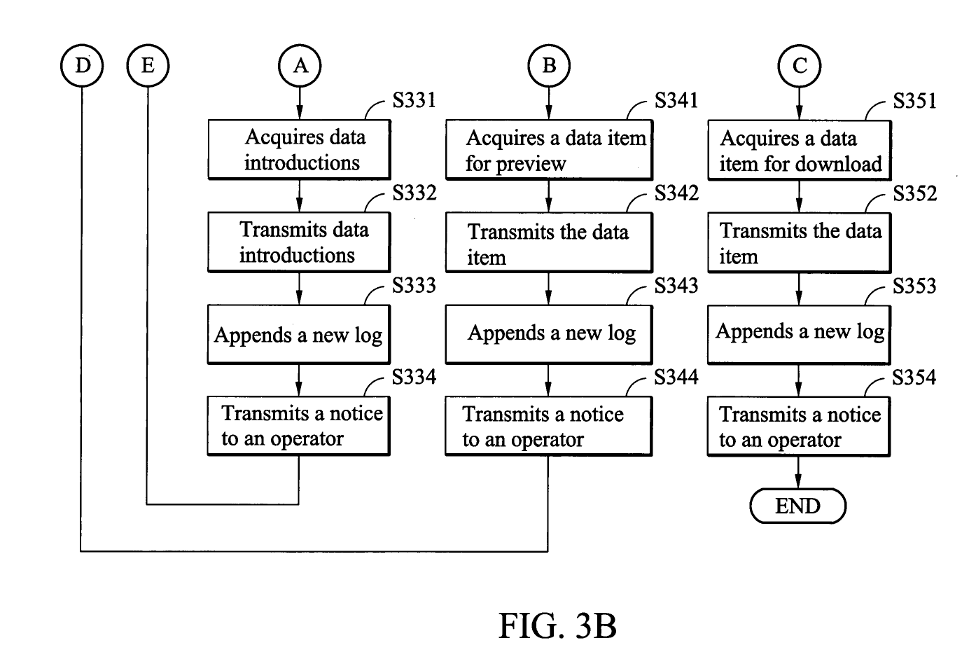

Some embodiments of a method of data archiving management comprise execution by a Web server, preferably implemented in one or more Web pages, business objects, or data objects. FIG. 3 is a flowchart showing an embodiment of a method for archiving data. In step S311, a login request, preferably a HTTP request, comprising a user account and a password is received. In step S312, it is determined whether the login request is authorized by detecting if the user account exists and the password correspond to the user account is correct, if so, the process proceeds to step S321, otherwise, the process proceeds to step S311. In step S321, a data acquisition request, preferably a HTTP request, comprising relevant arguments is received. In step S322, a data acquisition request type is determined. If the request type is a data query request then the process proceeds to step S331, if the request type is a data preview request, the process proceeds to step S341, and alternatively if the request type is a data download request, the process proceeds to step S351.

In step S331, at least one data introduction corresponding to the data query request is acquired. The data query request may provide query information, generally in HTTP query string format, HTML form object and the like, regarding specific data items for a particular query condition are required. For example, the specific query condition comprises a semiconductor product number, a wafer lot number, a period of time, an order number, a quotation number or combination thereof. Data introductions corresponding to the query information may be acquired by executing at least one relevant ANSI SQL queries, object method, file manipulation instruction, combination thereof. The user permission for access to data items corresponding to the acquired data introductions may be further examined, and when a user account is denied to access the data items, the corresponding data introductions are removed. In step S332, a Web page comprising the data introductions, generally in HTML format, is transmitted to the client computer 21. The Web page is then displayed via a browser in the client computer 21. In step S333, a new log containing the data query request may be generated and stored in a log file, a log database or a log object. The new log may contain additional information, such as the user account, query date, query time or others. In step S334, a notice indicating that specific data introductions have been acquired by the user account is transmitted to an operator, such as a contact window or data administrator, via an e-mail, a short message or similar.

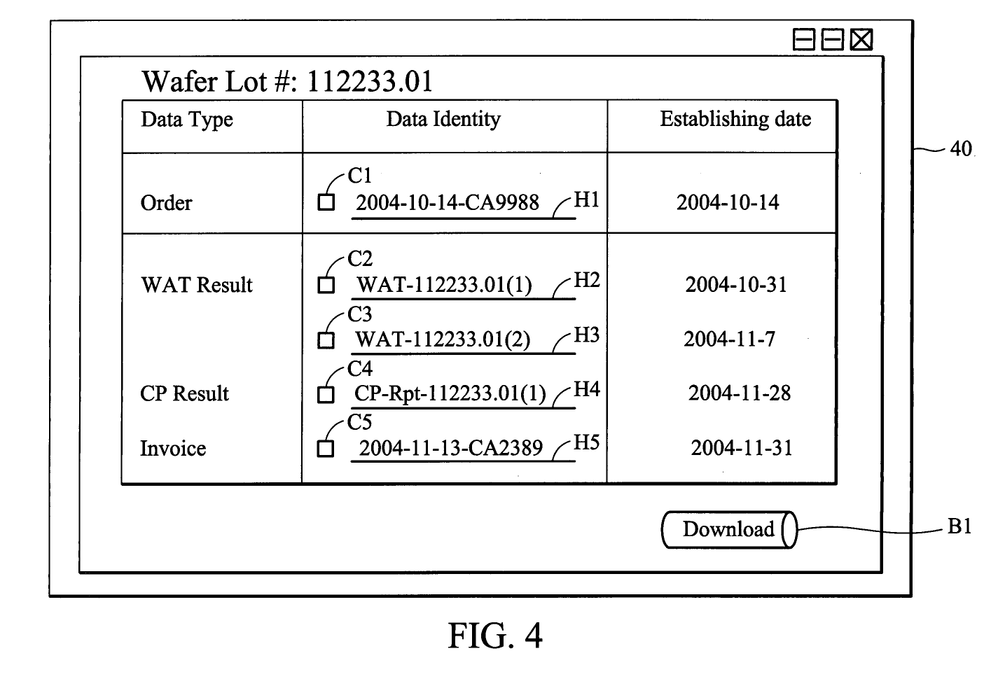

FIG. 4 is a screen diagram depicting an exemplary Web page comprising data introductions. The Web page 40 as shown in a browser of the client computer 21, comprises five data introductions and a button B1, and each data introduction contains a data type, a data identity and an established date. Embedded hyperlink objects H1 to H5 to the data identities are provided in the Web page. Check boxes C1 to C5 near the data identities are also provided. When a hyperlink is clicked, a data preview request with the corresponding data identity, generally in HTTP format, is transmitted to the Web server in the archiving system 22. When at least one check box is selected and the button B1 is clicked, a data download request with the selected data identity, generally in HTTP format, is transmitted to the Web server in the archiving system 22.

Referring to FIG. 3, in step S341, data corresponding to the data preview request is acquired. The data preview request may provide preview information, generally in HTTP query string format, HTML form object and the like, regarding the data item to be previewed. For example, the preview information describes a data identity corresponding to a specific order, quotation, WAT data report, CP test report, configuration file and the like. Before transmitting the preview data, either a package or a compressed data containing the preview data may be unpacked or uncompressed. The data corresponding to the preview information may be acquired by executing at least one relevant ANSI SQL queries, object method, file manipulation instruction, or the combination. In step S342, a Web page comprising the preview data, generally in HTML format, is transmitted to the client computer 21, and the Web page is displayed via a browser in the client computer 21. In step S343, a new log containing the data preview request may be generated and stored in a log file, a log database or a log object. The new log may also contain additional information, such as the user account, preview date, time or others. In step S344, a notice regarding that specific data has been previewed by the user account is transmitted to an operator, such as a contact window or data administrator, via e-mail, short message and the like.

In step S351, data corresponding to the data download request is acquired. The data download request may provide download information, generally in HTTP query string format, HTML form object and the like, regarding the data items for download. For example, the download information describes data identities corresponding to orders, quotations, WAT data reports, CP test reports, configuration files and the like. Before transmitting the download data, at least one package or compressed data containing the download data may be unpacked or uncompressed. The data corresponding to the download information may be acquired by executing at least one relevant ANSI SQL queries, object method, file manipulation instruction, or the combination. Some data may further be exported into various types of files, such as “.gif”, “.jpg”, “.rpt”, “.txt”, “.exp”, “.gds” or others for downloading. In step S352, at least one file corresponding to the data download request is transmitted to the client computer 21. In step S353, a new log containing the data download request may be generated and stored into a log file, a log database or a log object. The new log may also contain additional information, such as the user account, download date, time or others. In step S354, a notice regarding that specific data items have been downloaded by the user account is transmitted to an operator, such as a contact window or data administrator, via an e-mail, short message and the like.

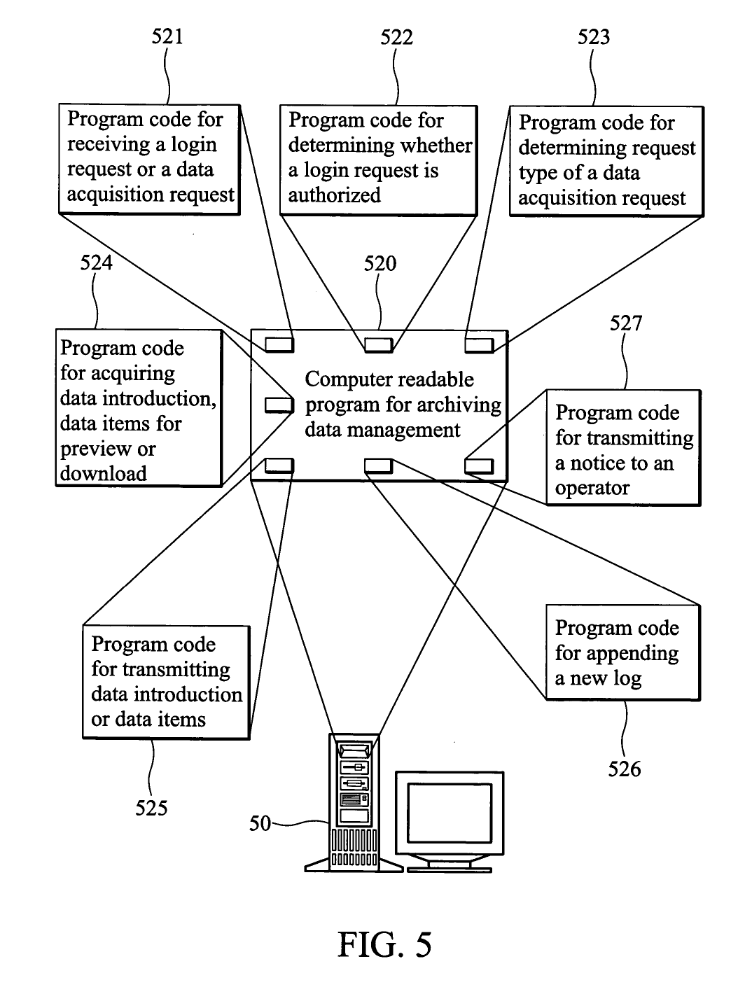

Also disclosed is a storage medium as shown in FIG. 5 storing a computer program 520 providing the disclosed method of data archiving management. The computer program product includes a storage medium 50 having computer readable program code embodied in the medium for use in a computer system. The computer readable program code comprises at least computer readable program code 521 receiving a login request or a data acquisition request, computer readable program code 522 determining whether a login request is authorized, computer readable program code 523 determining a data acquisition request type, computer readable program code 524 acquiring data introduction, data items for preview or download, computer readable program code 525 transmitting data introduction or data items, computer readable program code 526 appending a new log and computer readable program code 527 transmitting a notice to an operator.

Data archiving management systems and methods, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The disclosed methods and systems may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

While the invention has been described in preferred embodiment, it is not intended to limit the invention to the precise embodiments disclosed herein. Those who are skilled in this technology can still make various alterations and modifications without departing from the scope and spirit of this invention. Therefore, the scope of the invention shall be defined and protected by the following claims and their equivalents.

What is claimed is:

1. A system for data archiving management, the system comprising:
a storage device storing archive data and at least one data introduction, the archive data comprising at least one data item, the archive data generated after completing a corresponding semiconductor product, wafer or wafer lot, and the data introduction corresponding to the data item; and
a processing unit transmitting a first Web page comprising the data introduction comprising a data identity for the data item to a client computer, acquiring the data item from the archive data in response to a data preview request with the data identity, transmitting a second Web page comprising the data item to the client computer, and transmitting the data item to the client computer in response to a data download request with the data identity.

2. The system of claim 1 wherein the data item is generated during semiconductor manufacturing.

3. The system of claim 2 wherein the data item is a configuration file for a semiconductor fabrication tool, Grid Description Section (GDS) file, quotation, order, shipment, wafer acceptance test (WAT) data report or circuit probing (CP) test report.

4. The system of claim 1 wherein the processing unit further generates a new log containing information regarding that the data item has been previewed or downloaded by a user account, and stores the new log to the storage device.

5. The system of claim 1 wherein the processing unit further transmits a notice containing information regarding the data item has been previewed or downloaded by a user account to an operator.

6. The system of claim 5 wherein the notice is transmitted to the operator via e-mail or short message.

7. The system of claim 1 wherein the archive data is uncompressed or unpacked for data item acquisition.

8. The system of claim 1 wherein the processing unit further determines whether a user account has permission to access the data item, and transmits the data introduction corresponding to the data item when the user account has permission to access the data item.

9. The system of claim 1 wherein the processing unit receives the data item from a fabrication tool, a manufacturing execution system (MES), a management information system (MIS) or a testing equipment, and compresses or packs the data item to the archive data.

10. The system of claim 1 wherein the data preview request and the data download request are compatible with hypertext transfer protocol (HTTP).

11. The system of claim 1 wherein the first Web page and the second Web page are compatible with hypertext markup language (HTML).

12. A method for data archiving management comprising using a computer, comprising:
transmitting a first Web page comprising a data introduction comprising a data identity for a data item to a client computer, the data introduction corresponding to the data item;
acquiring the data item from archive data in response to a data preview request with the data identity, the archive data comprising at least the data item, the archive data generated after completing a corresponding semiconductor product, wafer or wafer lot;
transmitting a second Web page comprising the data item to the client computer; and
transmitting the data item to the client computer in response to a data download request with the data identity.

13. The method of claim 12 wherein the data item is generated during semiconductor manufacturing.

14. The method of claim 13 wherein the data item is a configuration file for a semiconductor fabrication tool, Grid Description Section (GDS) file, quotation, order, shipment, wafer acceptance test (WAT) data report or circuit probing (CP) test report.

15. The method of claim 12 further comprising the steps of:
generating a new log containing information regarding that the data item has been previewed or downloaded by a user account; and
storing the new log to a storage device.

16. The method of claim 12 further comprises a step of transmitting a notice containing information regarding the data item has been previewed or downloaded by a user account to an operator.

17. The method of claim 16 wherein the notice is transmitted to the operator via e-mail or short message.

18. The method of claim 12 wherein the archive data is uncompressed or unpacked for data item acquisition.

19. The method of claim 12 further comprises the steps of:
determining whether a user account has permission to access the data item; and
transmitting the data introduction corresponding to the data item when the user account has permission to access the data item.

20. The method of claim 12 further comprises the steps of:
receiving the data item from a fabrication tool, a manufacturing execution system (MES), a management information system (MIS) or a testing equipment; and
compressing or packing the data item to the archive data.

21. The method of claim 12 wherein the data preview request and the data download request are compatible with hypertext transfer protocol (HTTP).

22. The method of claim 12 wherein the first Web page and the second Web page are compatible with hypertext markup language (HTML).

23. A system for data archiving management, the system comprising:
a storage device storing archive data and at least one data introduction, the archive data comprising at least one data item, the archive data been generated after completing a corresponding semiconductor product, wafer or wafer lot, and the data introduction corresponding to the data item; and
a processing unit determining whether a user account has permission to access the data item, transmitting a first Web page comprising the data introduction comprising a data identity for the data item to a client computer when the user account has permission to access the data item, acquiring the data item from the archive data in response to a data preview request with the data identity, transmitting a second Web page comprising the data item to the client computer, transmitting the data item to the client computer in response to a data download request with the data identity, generating a new log containing information regarding that the data item has been previewed or downloaded by a user account, storing the new log to the storage device, and transmitting a notice containing information regarding the data item has been previewed or downloaded by a user account to an operator.
